(19) United States
(12) Patent Application Publication
(10) Pub. No.: US 2005/0002730 A1
(43) Pub. Date: Jan. 6, 2005

(54) Steel rod connector

(76) Inventor: George Hsieh, Taipei (TW)

Correspondence Address: PRO-TECHTOR INTERNATIONAL, 20775 Norada Court, Saratoga, CA, 95070-3018, US

(21) Appl. No.: 10/881,828

(22) Filed: Jun. 29, 2004

(30) Foreign Application Priority Data
Jul. 3, 2003 (JP) 2003-3964

(51) Int. Cl. F16B 1/00

(52) U.S. Cl. 403/286

(57) ABSTRACT

A steel rod connector comprises a tube, a left nut and a right nut. The tube has an inner thread and a peripheral locking part, with the peripheral locking part having elongated checking holes. The left and right nuts secure a left and right steel rod, fastened to the tube, respectively. After inserting the left and right steel rods into the tube by left and right insertion lengths, respectively, the checking holes allow to judge immediately by eyesight whether the left and right insertion lengths have reached safe minimal values.

### BACKGROUND OF THE INVENTION

1. Field of the Invention

The present invention relates to a steel rod connector, particularly to a steel rod connector, which allows to check minimal safe insertion lengths immediately by eyesight.

2. Description of Related Art

As shown in FIGS. 5-6, a conventional steel rod connector comprises: a tube 1; a left nut 2, securing a left steel rod 7 fastened to the tube 1; and a right nut 3, securing a right steel rod 8 fastened to the tube 1. The tube 1 has an inner thread 4. A locking part 5 with an inlet opening 6 surrounds the tube 1.

For connecting the left steel rod 7 and the right steel rod 8, the left nut 2 is first put over the left steel rod 7, then the left steel rod 7 is screwed into the inner thread 4 of the tube 1 up to a desired insertion length. Finally, the left nut 2 is screwed tight against the tube 1. The right steel rod 8 is fastened to the tube 1 in the same way, using the right nut 3, so that finally the left steel rod 7 and the right steel rod 8 are connected to each other.

After the connection has been performed, cement is poured through the inlet opening 6, filling the tube 1 and reinforcing the connection between the left steel rod 7 and the right steel rod 8, so that the steel rod connector will not easily break.

Steel rod connectors are important for construction work. Steel rods are produced according to standards, but high-rise buildings often have heights that exceed legnths of steel rods. Using previous methods of having steel rods overlap results in decreased structural strength. Employing steel rod connectors, however, allows to connect steel rods without loss of strength.

Conventional steel rod connectors do not allow to check for minimal insertion lengths immediately by eyesight, when the left and right steel rods 7, 8 are screwed into the tube 1. It is rather required to measure and mark insertion lengths before, which results in a longer and more expensive process.

### SUMMARY OF THE INVENTION

It is therefore an object of the present invention to provide a steel rod connector, which allows to check minimal safe insertion lengths immediately by eyesight.

Another object of the present invention is to provide a steel rod connector that saves construction time.

A further object of the present invention is to provide a steel rod connector that saves labor efforts.

The present invention can be more fully understood by reference to the following description and accompanying drawings.

### DETAILED DESCRIPTION OF THE PREFERRED EMBODIMENT

As shown in FIGS. 1-4, the steel rod connector of the present invention comprises: a tube 10, having an inner thread 13 and a peripheral locking part 11; a left nut 20, securing a left steel rod 40 fastened to the tube 10; and a right nut 30, securing a right steel rod 50 fastened to the tube 10.

For connecting the left steel rod 40 and the right steel rod 50, the left and right nuts 20, 30 are first put over the left and right steel rods 40, 50, respectively. Tthen the left and right steel rods 40, 50 are screwed into the inner thread 13 of the tube 10 up to desired insertion lengths. Finally, the left and right nuts 20, 30 are screwed tight against the tube 10, so that finally the left steel rod 40 and the right steel rod 50 are connected to each other.

The main characteristic of the present invention lies in that the locking part 11 has a plurality of elongated checking holes 12, allowing immediately by eyesight to check the insertion lengths of the left and right steel rods 40, 50 into the tube 10 for exceeding or falling short of minimal safe values. Checking the insertion lengths thus does not require previous measuring and marking, so that time and labor effort are saved.

In FIG. 6A, showing a sectional view of a conventional steel rod connector, the minimal safe value of the insertion length is indicated by P, and a maximum viewing angle and a resulting line of sight for a worker are indicated by an arrow Q. Evidently judging if the minimal safe value of the insertion length has been reached is very hard.

In FIG. 4A, showing a sectional view of the steel rod connector of the present invention, the minimal safe value of the insertion length is indicated by V, and maximum viewing angles and resulting lines of sight for a worker are indicated by arrows S, T. Evidently judging if the minimal safe value of the insertion length has been reached is very easy.

As the above explanation shows, a worker, by peeking through one of the plurality of checking holes 12, is easily able to judge if the minimal safe value of the insertion length has been reached, resulting in saving of time, labor effort and cost.

While the invention has been described with reference to a preferred embodiment thereof, it is to be understood that modifications or variations may be easily made without departing from the spirit of this invention which is defined by the appended claims.

### BRIEF DESCRIPTION OF THE DRAWINGS

FIG. 1 is a sude view of the steel rod connector of the present invention.

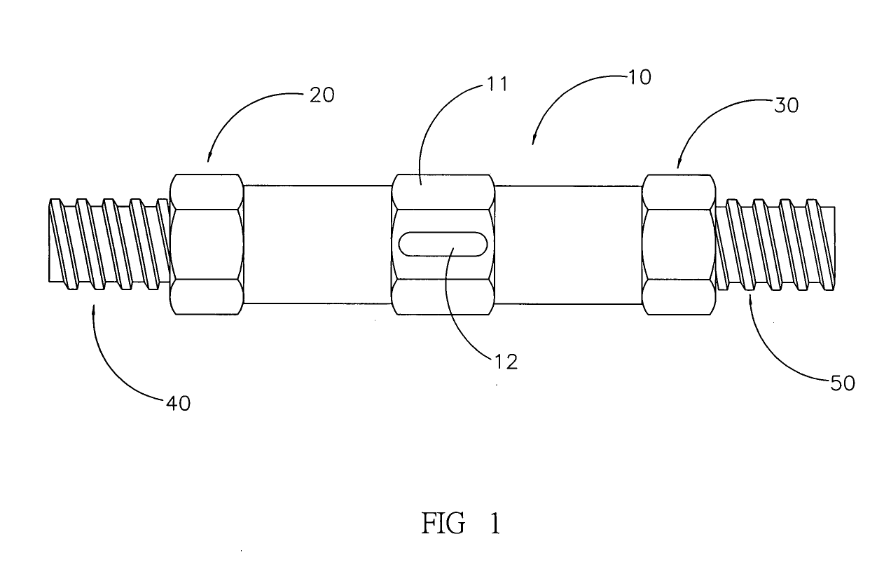

FIG. 2 is an exploded side view of the steel rod connector of the present invention.

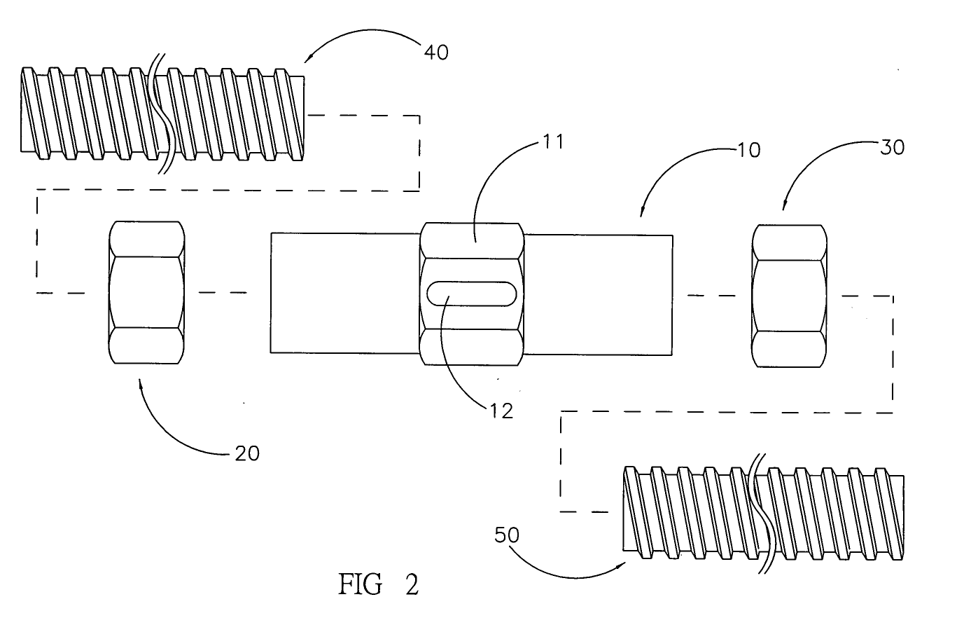

FIG. 3 is a sectional view of the steel rod connector of the present invention without the left and right steel rods.

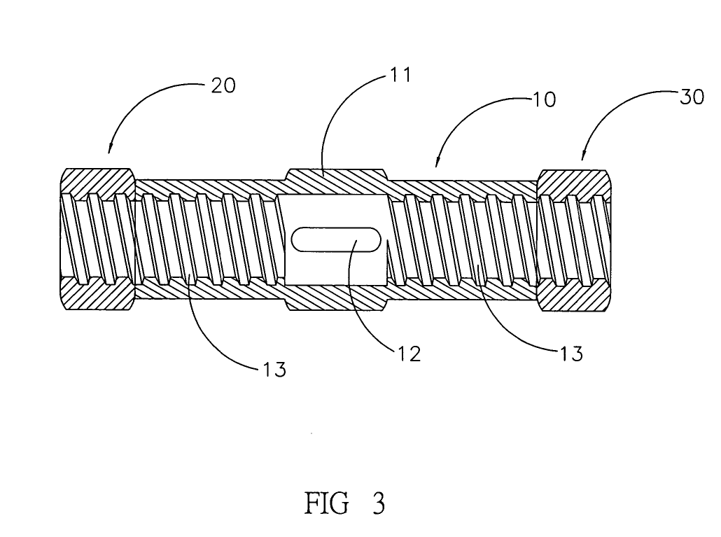

FIG. 4 is a partially sectional view of the steel rod connector of the present invention after having connected steel rods.

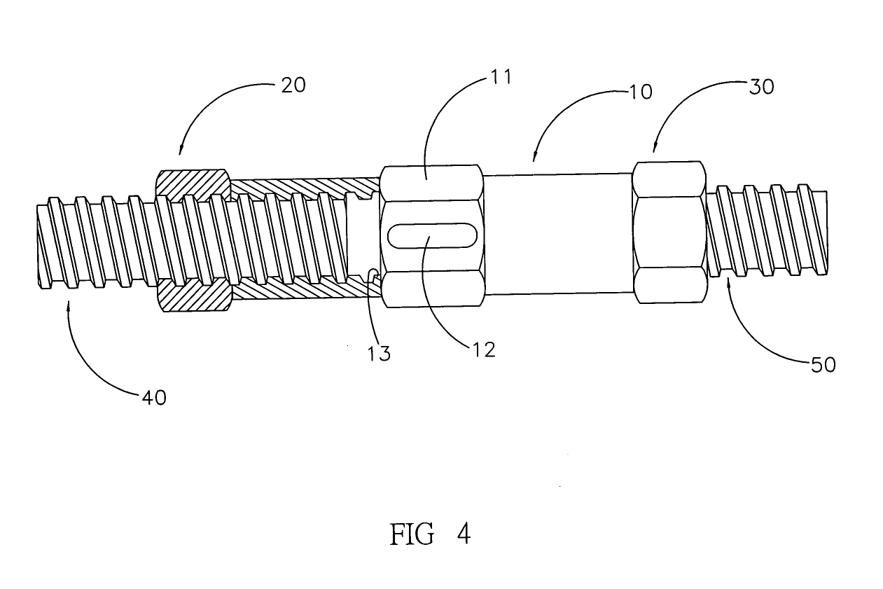

FIG. 4A is a schematic illustration of connecting steel rods by the steel rod connector of the present invention.

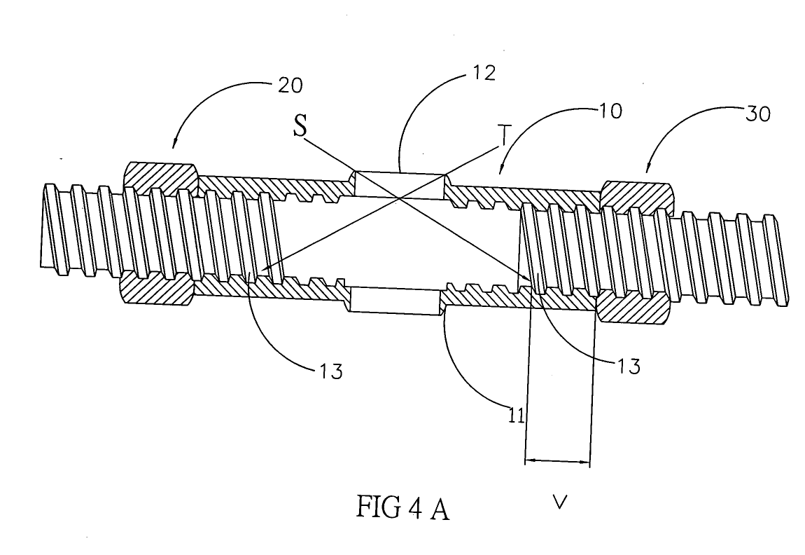

FIG. 5 is a side view of a conventional steel rod connector.

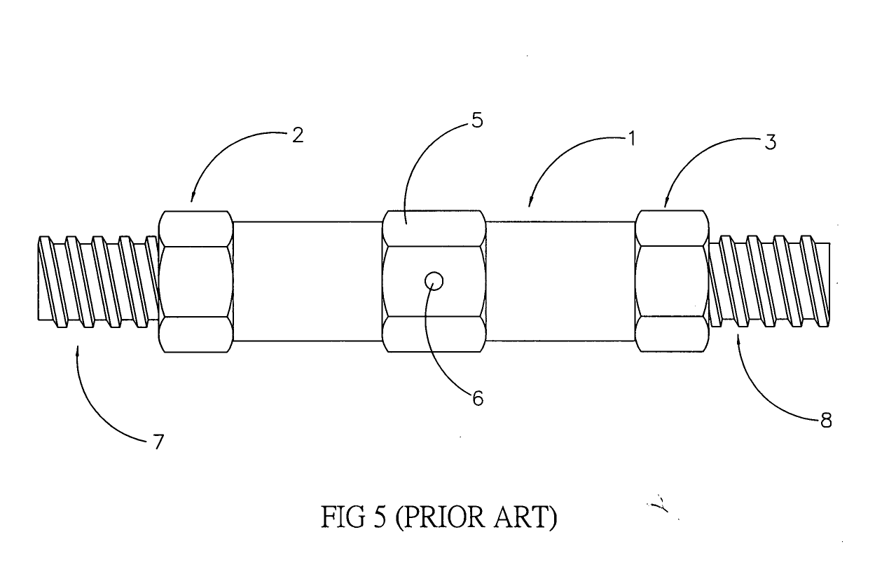

FIG. 6 is a partially sectional view of a conventional steel rod connector after having connected steel rods.

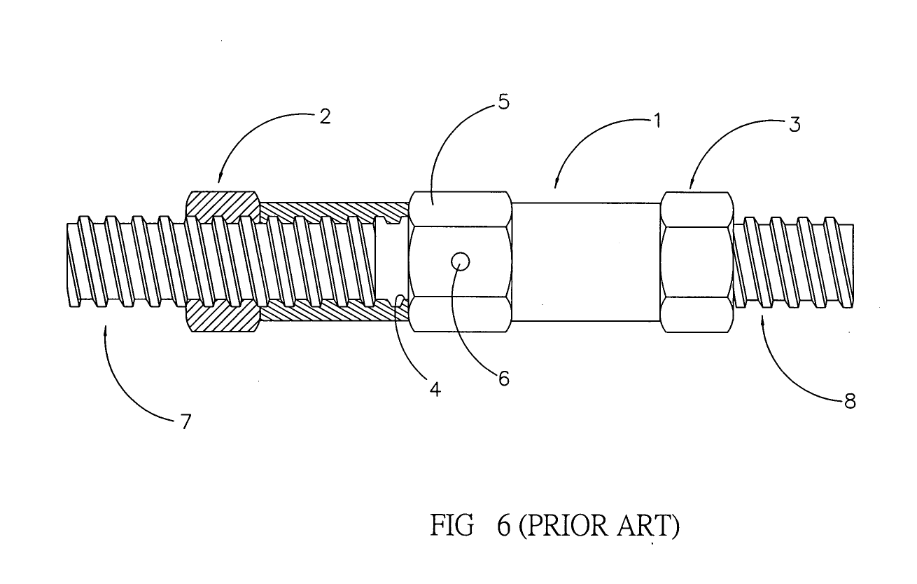

FIG. 6A is a schematic illustration of connecting steel rods by a conventional steel rod connector.

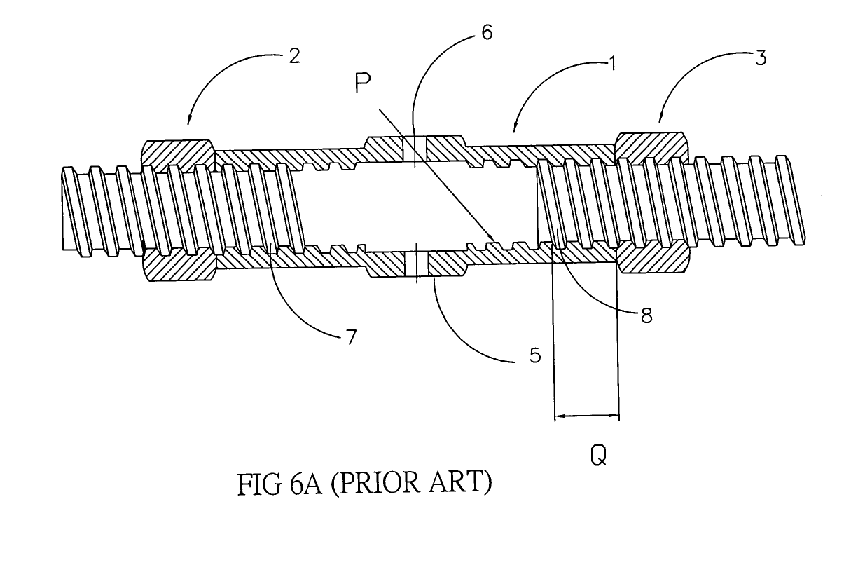

1. A steel rod connector, comprising:
a tube, having an inner thread and a peripheral locking part, said peripheral locking part having at least one elongated checking hole;
a left nut, securing a left steel rod fastened to said tube; and
a right nut, securing a right steel rod fastened to said tube;
wherein, after inserting said left and right steel rods into said tube by left and right insertion lengths, respectively, said at least one elongated checking hole allows to judge immediately by eyesight whether said left and right insertion lengths have reached safe minimal values.
